(19) United States
(12) Patent Application Publication
(10) Pub. No.: US 2005/0200695 A1
(43) Pub. Date: Sep. 15, 2005

(54) Transceiver system, transmitter and receiver and information processing method

(76) Inventor: Teruya Maeda, Kanagawa (JP)

Correspondence Address: FROMMER LAWRENCE & HAUG LLP, 745 FIFTH AVENUE, NEW YORK, NY, 10151, US

(21) Appl. No.: 11/048,533

(22) Filed: Feb. 1, 2005

(30) Foreign Application Priority Data
Feb. 3, 2004 (JP) 2004-026756

(51) Int. Cl. H04N 7/14; H04N 5/14; H04N 9/64

(52) U.S. Cl. 348/14.02; 348/571

(57) ABSTRACT

A base station apparatus creates a synthesized moving image signal resulting from the synthesis of multiple moving image signals and encodes and converts the synthesized moving image signal to the encoded moving image signal and transmits the encoded moving image signal. In response thereto, a monitor apparatus extracts a moving image signal required by the monitor apparatus from the synthesized moving image signal obtained from the received encoded moving image signal. The extraction processing includes a transmission from the base station apparatus to each monitor apparatus and is implemented by the monitor apparatus based on extract command information having information details indicating a method of extracting a moving image signal from a synthesized moving image signal. Under the system configuration, one signal processing system is required for the encoding processing in the base station apparatus.

### BACKGROUND OF THE INVENTION

1. Field of the Invention

The present invention relates to a transceiver system for exchanging a moving image signal and a transmitter and receiver included in the transceiver system. The present invention further relates to an information processing method to be implemented in the transceiver system, transmitter and receiver.

2. Description of the Related Art

The present applicant has proposed an Audio/Video (AV) system, for example, in which a base station apparatus and a monitor apparatus are connected by wireless communication (refer to JP-A-2001-358966).

The base station apparatus of the AV system includes a tuner for television broadcasting, for example, and thereby can receive, select and demodulate a television signal to a video signal (moving image signal). The base station apparatus further includes a video signal input terminal, for example, and thereby has a function of externally inputting a video signal. Then, a video signal resulting from the processing can be converted to compressed and encoded video data, which can be transmitted and output by radio.

The monitor apparatus is small enough for indoor mobile use, for example, and can receive encoded video data transmitted from the base station apparatus by radio. The monitor apparatus performs decoding processing on and expands the received video data and can display and output the result as an image.

The monitor apparatus can further perform operations for controlling different base stations, including selection of a television broadcasting station and selection of a video signal serving as an external source, and transmits the operation information to the base station apparatus. The base station apparatus controls the tuner to switch a selected channel and/or switch an input of an external source in accordance with the received operation information.

With the AV system, a user can carry and use the monitor apparatus in any indoor place. In other words, within a range that the monitor apparatus is communicable with the base station apparatus, a user can view contents which can be obtained by the base station apparatus such as a television broadcast and is output by the monitor apparatus.

Presently, the AV system is provided to a user as one including a pair of one base station apparatus and one monitor apparatus. However, the AV system may be advanced to an AV system including a combination of one base station apparatus and multiple monitor apparatus.

The applications of the AV system including one base station apparatus and multiple monitor apparatus are as follows. First of all, one base station apparatus may be provided in a house, and each of multiple monitor apparatus may be owned and used by a residence such as a family member living in the house, for example. In this case, images of different kinds of contents are output to the multiple monitor screens, respectively. In other words, a system is given in which each different video signal can be transmitted from one common base station apparatus to each of the multiple monitor apparatus.

With the construction of the AV system, each of multiple users can enjoy images of preferred contents output by the monitor apparatus used by the user himself/herself. Furthermore, since one base station apparatus is common to multiple monitor apparatus, users adopting and using the AV system can obtain merits that a space in a house is not occupied by many base station apparatus and the purchasing costs can be reduced therefor, for example.

As described above, a base station apparatus converts video signals to compressed and encoded video data to transmit. The monitor apparatus decodes the received compressed and encoded video data to display. In other words, the base station apparatus includes a video encoder for compressing and encoding video signals while the monitor apparatus includes a video decoder for decoding the compressed and encoded video signals. Furthermore, as described above, the AV system assumes that a base station apparatus and a monitor apparatus are provided in a one-to-one relationship presently, and video signals transmitted from the base station apparatus to the monitor apparatus therefore correspond to one piece of contents. Therefore, the video encoder of the base station apparatus includes only one channel corresponding to one input of video signals, and the video decoder of the monitor apparatus also includes only one channel corresponding to an input of received compressed and encoded video signals.

In the AV system including one base station apparatus and multiple monitor apparatus under this construction, the base station apparatus naturally has a construction as shown in FIG. 15, for example, in order to transmit each different signal from one common base station apparatus to each of multiple monitor apparatus. For simple description, FIG. 15 shows a construction of a base station apparatus for a case that the maximum number of monitor apparatus in the AV system is two.

Here, the base station apparatus shown in FIG. 15 obtains a moving image signal (video signals) A and a moving image signal B, which are different kinds of video contents, as video sources of moving images corresponding to the two monitor apparatus.

In accordance with these two moving image signals A and B, a first video encoder 12-1 and a second video encoder 12-2 are provided therein. Each of the first video encoder 12-1 and second video encoder 12-2 compresses and encodes an input moving image signal (video signal) by a predetermined technique and outputs the result as encoded moving image data. In this case, the moving image signals A and B are simultaneously input to the first video encoder 12-1 and second video encoder 12-2, respectively. In other words, the first video encoder 12-1 outputs encoded moving image data resulting from compression and encoding of a moving image signal A while the second video encoder 12-2 outputs encoded moving image data resulting from compression and encoding of a moving image signal B.

The encoded moving image data of the moving image signal A and the encoded moving image data of the moving image signal B output from the first video encoder 12-1 and second video encoder 12-2 in this way are transferred to and temporarily stored in the memory 14 under the control of a control portion (that is, central processing unit (CPU)) 13. Then, the control portion 13 loads the encoded moving image data of the moving image signal A and encoded moving image data of the moving image signal B held in the memory 14 sequentially in predetermined timing and transfers them to a communication portion 15. Under the control of the control portion 13, the communication portion 15 performs processing for converting to communication data, such as packetizing, on the transferred encoded moving image data and transmits and outputs the result as transmit moving image data to a destination monitor apparatus. Here, when two monitor apparatus of monitor apparatus A and B, not shown, are provided, the transmit moving image data of the moving image signal A and the transmit moving image data of the moving image signal B are transmitted to the monitor apparatus A and monitor apparatus B, respectively, serving as the destinations.

Thus, in order to allow one base station apparatus to transmit moving image signals as different pieces of contents to multiple monitor apparatus simultaneously, the number of video encoders provided in the base station apparatus corresponds to the number of monitor apparatus included in the system, that is, the maximum number of moving image signals to be transmitted simultaneously.

In this case, when transmit moving image data of the moving image signals A and B are transmitted simultaneously from the base station apparatus shown in FIG. 15 in the manner as described above, for example, the monitor apparatus A only receives the transmit moving image data of the moving image signal A, and the monitor apparatus B only receives the transmit moving image data of the moving image signal B.

Then, the monitor apparatus A obtains the received moving image data as encoded moving image data and decodes the data by the video decoder and displays the result as a moving image. Similarly, the monitor apparatus B obtains the received transmit moving image data as encoded moving image data and decodes the data by the video decoder and displays the result as a moving image.

For the processing and operation of decoding and displaying to be performed in the monitor apparatus, the monitor apparatus only needs to decode and display received and obtained encoded moving image data by a video decoder of one channel. In other words, because of this point, the monitor apparatus may have the same construction as that of the monitor apparatus of the AV system including one base station apparatus and one monitor apparatus.

However, when the construction of the base station apparatus shown in FIG. 15 is adopted, the number of video encoders to be implemented must correspond to the maximum number of moving image signals to be simultaneously transmitted in accordance with the number of monitor apparatus included in the system. Thus, the circuit size of the base station apparatus is increased, which increases the substrate size and apparatus size and also increases the weight.

Though, as described with reference to FIG. 15, the traffic of encoded moving image data encoded and output simultaneously from multiple video encoders is adjusted under the control of the control portion (that is, a CPU), the control processing puts a significantly large load on the CPU in reality, which lowers the operational reliability.

Furthermore, since multiple pieces of encoded moving image data each of which is encoded independently must be transmitted simultaneously in an actual transmission operation from the base station apparatus, the amount of communication over a communication network for exchanging the encoded moving image data increases. For example, such an increase in amount of communication may unpreferably cause a communication failure.

These problems become bigger and more significant as the maximum number of monitor apparatus compliant with an AV system increases.

### SUMMARY OF THE INVENTION

Accordingly, in consideration of these problems, the invention has a construction below as a transceiver system.

According to one aspect of the invention, there is provided a transceiver system of the invention includes a transmitter and a receiver.

The transmitter includes a synthesizing unit synthesizing multiple moving image signals and creating a synthesized moving image signal thereby, an encoding unit encoding a moving image signal to be input and outputting the encoded moving image signal and allowing the synthesized moving image signal to input as a moving image signal to be input, and an image signal transmitting unit transmitting an encoded moving image signal output from the encoding unit to multiple receivers.

The receiver includes an image signal receiving unit receiving an encoded moving image signal transmitted by the image signal transmitting unit, a decoding unit decoding an encoded moving image signal received by the image signal receiving unit and outputting a moving image signal thereof, and a moving image signal extracting unit, when a moving image signal output from the decoding unit is the synthesized moving image signal, extracting a required moving image signal from multiple moving image signals synthesized to the moving image signal.

The transmitter may include a synthesizing unit synthesizing multiple moving image signals and creating a synthesized moving image signal thereby, an encoding unit encoding a moving image signal to be input and outputting the encoded moving image signal and allowing the synthesized moving image signal to input as a moving image signal to be input, an image signal transmitting unit transmitting an encoded moving image signal output from the encoding unit to multiple receivers, and an extract command information transmitting unit creating and transmitting extract command information for commanding a method of extracting a moving image signal from a synthesized moving image signal to each of multiple receivers, which are destinations that an encoded moving image signal resulting from encoding of the synthesized moving image signal by the encoding unit is transmitted to by the image signal transmitting unit.

The receiver may include an image signal receiving unit receiving an encoded moving image signal transmitted by the image signal transmitting unit, a decoding unit decoding an encoded moving image signal received by the image signal receiving unit and outputting a moving image signal thereof, an extract command information receiving unit receiving the extract command information transmitted by the transmitter for commanding a method of extracting a moving image signal from a synthesized moving image signal, and a moving image signal extracting unit, when a moving image signal output from the decoding unit is the synthesized moving image signal, extracting a required moving image signal from multiple moving image signals synthesized to the synthesized moving image signal based on extract command information received by the extract command information receiving unit.

According to another aspect of the invention, there is provided an information processing method for a transceiver system including a transmitter and a receiver.

The transmitter performs a synthesizing step of synthesizing multiple moving image signals and creating a synthesized moving image signal thereby, an encoding step of encoding a moving image signal to be input and outputting the encoded moving image signal and also encoding the synthesized moving image signal as the moving image signal to be input, and an image signal transmitting step of transmitting an encoded moving image signal output from the encoding step to multiple receivers.

The receiver performs an image signal receiving step of receiving an encoded moving image signal transmitted by the image signal transmitting step, a decoding step of decoding an encoded moving image signal received by the image signal receiving step and outputting a moving image signal thereof, and a moving image signal extracting step of, when a moving image signal output from the decoding step is the synthesized moving image signal, extracting a required moving image signal from multiple moving image signals synthesized to the moving image signal.

According to another aspect of the invention, there is provided an information processing method for a transmitter.

In this case, the transmitter performs a synthesizing step of synthesizing multiple moving image signals and creating a synthesized moving image signal thereby, an encoding step of encoding a moving image signal to be input and outputting the encoded moving image signal and also encoding the synthesized moving image signal as the moving image signal to be input, an image signal transmitting step of transmitting an encoded moving image signal output from the encoding step to multiple receivers, and an extract command information transmitting step of creating and transmitting extract command information for commanding a method of extracting a moving image signal from a synthesized moving image signal to each of multiple receivers, which are destinations that an encoded moving image signal resulting from encoding of the synthesized moving image signal by the encoding step is transmitted to by the image signal transmitting step.

According to another aspect of the invention, there is provided an information processing method for a receiver.

In this case, the receiver performs an image signal receiving step of receiving an encoded moving image signal transmitted from a transmitter, a decoding step of decoding an encoded moving image signal received by the image signal receiving step and outputting a moving image signal thereof, an extract command information receiving step of receiving extract command information transmitted from a transmitter for commanding a method of extracting a moving image signal from a synthesized moving image signal, and a moving image signal extracting step of, when a moving image signal output from the decoding step is the synthesized moving image signal, extracting a required moving image signal from multiple moving image signals synthesized to the moving image signal based on extract command information received by the extract command information receiving step.

In a transceiver system according to the invention with these constructions, a transmitter thereof creates, encodes and converts to an encoded moving image signal a synthesized moving image signal resulting from synthesis of multiple moving image signals. In response thereto, a receiver thereof extracts a required moving image signal from the synthesized moving image signal obtained from the received encoded moving image signal.

The transmitter of the transceiver system creates, encodes and converts to an encoded moving image signal a synthesized moving image signal resulting from synthesis of multiple moving image signals. At the same time, the transmitter creates and transmits extract command information to multiple receivers serving as destinations of the synthesized moving image signal. The extract command information has information details for commanding a method of extracting a moving image signal from a synthesized moving image signal.

The receiver extracts a moving image signal from a synthesized moving image signal obtained from the received encoded moving image signal. In this case, a moving image signal is extracted in accordance with a command indicated by the received extract command information.

Commonly in these constructions, first of all, the transmitter inputs and encodes a synthesized moving image signal resulting from synthesis of multiple moving image signals to one moving image signal. In this case, irrespective of the number of moving image signals to be synthesized, a moving image signal to be encoded is one of the moving image signals synthesized. When a synthesized moving image signal resulting from synthesis of multiple moving image signals in this way is received, the receiver can extract a moving image signal from the synthesized moving image signal.

In the construction for extracting a moving image signal, transmitting the extract command information by a transmitter and extracting a moving image signal in accordance with the received extract command information by a receiver can establish an inter-apparatus relationship that the transmitter transmitting a synthesized moving image signal commands (controls) to extract while the receiver extracts a moving image signal from a synthesized moving image signal under the control.

Hence, in a system including one transmitter encoding and transmitting moving image signals (video signals) to multiple receivers according to the invention, one signal processing system is only required for encoding irrespective of the number of moving image signals to be transmitted even when moving image signals of different kinds of contents are encoded and transmitted from the transmitter to the multiple receivers. Thus, an increase in costs of the transmitter can be avoided, and increases in circuit substrate size and apparatus size can be also avoided. Even when a synthesized moving image signal resulting from synthesis of multiple moving image signals is transmitted from the transmitter in this way, the receiver can extracts a moving image signal from the synthesized image signal. Therefore, the receiver can obtain a normal moving image signal without problems.

Furthermore, under the construction that a moving image signal is extracted in accordance with an extract command signal, the extraction of a moving image signal from a synthesized moving image signal can be performed efficiently in the system.

### BRIEF DESCRIPTION OF THE DRAWINGS

FIG. 1 is a diagram schematically showing a construction of an AV system according to an embodiment of the invention;

FIG. 2 is a block diagram showing an internal construction example of a base station apparatus included in the AV system according to the embodiment;

FIG. 3 is a block diagram showing an internal construction example of a monitor apparatus included in the AV system according to the embodiment;

FIG. 4 is a diagram showing an operational example of the AV system according to the embodiment;

FIG. 5 is a diagram showing another operational example of the AV system according to the embodiment;

FIG. 6 is a diagram showing another operational example of the AV system according to the embodiment;

FIG. 7 is a diagram showing another operational example of the AV system according to the embodiment;

FIG. 8 is a diagram showing another operational example of the AV system according to the embodiment;

FIGS. 9A and 9B are diagrams each schematically showing a synthesized form of moving image signals in a synthesized moving image signal;

FIGS. 10A to 10C are diagrams each schematically showing a synthesized form of moving image signals in a synthesized moving image signal;

FIGS. 11A and 11B are diagrams schematically showing examples with different resolutions of moving image signals in accordance with the number of synthesized moving image signal;

FIG. 12 is a flowchart illustrating a processing operation to be performed by a monitor apparatus for requesting a moving image to a base station apparatus;

FIG. 13 is a flowchart illustrating a control processing operation to be performed by a monitor apparatus for implementing signal processing for a case that transmit moving image data serving as a synthesized image signal is received;

FIG. 14 is a flowchart illustrating a processing operation to be performed by a base station apparatus in response to a request for a moving image; and

FIG. 15 is a block diagram showing a construction example of a base station apparatus in a conventional example.

### DESCRIPTION OF THE PREFERRED EMBODIMENTS

Preferred embodiments (which will be simply called embodiments hereinafter) of the invention will be described below. Here, an Audio/Video (AV) system for indoor use such as in-house use is adopted as an embodiment, in which a base station apparatus that transmits video/audio data and a monitor apparatus that receives video/audio data transmitted from the base station apparatus and can output the data as an image/voice are connected by wireless communication. In other words, the base station apparatus corresponds to a transmitter in the present invention while the monitor apparatus corresponds to a receiver in the present invention.

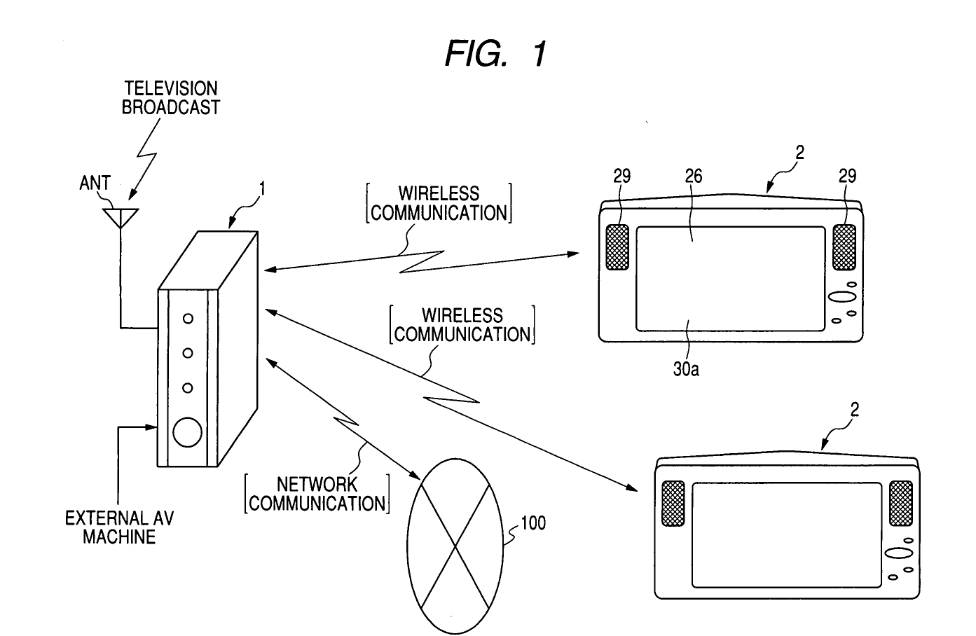

FIG. 1 schematically shows a constructional concept of the AV system according to this embodiment. The AV system of this embodiment has an apparatus construction in a relationship that multiple monitor apparatus corresponds to one base station apparatus. Here, two monitor apparatus corresponds to one base station apparatus.

The AV system of this embodiment includes a base station apparatus 1 and monitor apparatus 2 shown in FIG. 1 and is used in a house. The base station apparatus 1 and the monitor apparatus 2 can communicate with each other, as described later.

The base station apparatus 1 is fixed in some place in a house and has a function of receiving, selecting and decoding a television broadcast and obtains video/audio information thereby.

Thus, an antenna ANT for receiving a television broadcast, which corresponds to the television broadcast receiving function, can be connected to the base station apparatus 1. The base station apparatus 1 selects and decodes a broadcast signal received by the antenna ANT and obtains video/audio information serving as a television signal thereby. The base station apparatus 1 converts the television signal to video/audio signal data compressed and encoded by a predetermined technique.

The base station apparatus 1 of this embodiment further includes a video input terminal, for example, and can obtain video/audio signal output from an external AV machine connecting to the video input terminal and input through the video input terminal and can also convert the video/audio signal to compressed and encoded video/audio signal data.

The base station apparatus 1 further has an Internet (network) connecting function. Thus, the base station apparatus 1 connects to the Internet, for example, so as to access a Web site over the Internet or exchange an electronic mail. Thus, application software so-called Web browser or mailer is installed in the base station apparatus 1 for viewing a Web site and creating and exchanging an electronic mail.

The base station apparatus 1 creates an interface image of the Web browser or mailer, for example, as a video signal and can output the interface image instead of a video signal of a television broadcast as described above or synthesize the interface image with a video signal of a television broadcast. The video signal created in this way can be converted to compressed and encoded video signal data.

The base station apparatus 1 can transmit video/audio signal data resulting from compression and encoding as described above as radio waves, first of all. In other words, the base station apparatus 1 can transmit, by radio, contents information such as image information including an image of a received and selected television broadcast, a video/audio signal input from an AV machine and an interface image including an Internet image. The base station apparatus 1 can transmit and output by radio non-image information data such as a command. Information transmitted by the base station apparatus 1 in this way can be received by the monitor apparatus 2, which will be described later.

The base station apparatus 1 and the monitor apparatus 2 can exchange a command by radio communication. Thus, the base station apparatus 1 can be controlled by the monitor apparatus 2 or, conversely, the monitor apparatus 2 can be controlled by the base station apparatus 1.

Here, the radio communication has a communicable distance of about 30 m. In other words, the radio communication is for a use environment in which the base station apparatus 1 and the monitor apparatus 2 can be placed relatively closely, such as within the same house.

The monitor apparatus 2 has a size and form for user's mobile.

The monitor apparatus 2 can receive and input a signal transmitted by radio as radio waves from the base station apparatus 1 in the above-described manner. For example, when an input and received signal is contents information that is compressed and encoded video/audio signal data, the monitor apparatus 2 performs decoding processing thereon and obtains video/audio signal thereby.

The monitor apparatus 2 includes a display portion 26 including a display device such as a liquid crystal display (LCD) and causes the display portion 26 to display a video signal of the obtained contents information as an image. In other words, the monitor apparatus 2 can display video/audio information of a television broadcast received and selected by the base station apparatus 1, video/audio information input and obtained from an AV machine and a user interface image of application software operating in the base station apparatus 1. The monitor apparatus 2 further includes a function of outputting audio information including a speaker 29 so that a sound of video/audio information and/or a sound corresponding to a manipulation on a user interface image can be output.

A touch panel 30a is mounted to a display part of the display portion 26, and manipulation information is created by detecting a manipulation on the touch panel 30a.

The information of a manipulation on the touch panel 30a is transmitted from the display portion 26 to the base station apparatus 1 by radio as required, and the base station apparatus 1 performs required control processing based on the received information. Performing an operation including the transmitting/receiving operation allows switching between a function as a monitor of a television receiver and an Internet function and/or selecting a channel for a television broadcast and/or selecting an external video/audio source. Furthermore, a manipulation can be performed on an interface screen of application software such as a Web browser and a mailer, which is displayed as described above.

In this way, the base station apparatus 1 has functions as an interface for transmitting contents information, which can be obtained from the surroundings, such as obtaining video/audio information from a television broadcast or an external AV machine, receiving and obtaining a kind of information such as Web contents over the Internet, and transmitting the obtained contents information.

The monitor apparatus 2 further has a function as a user interface for outputting, as an image and/or a sound, video/audio information obtained by the base station apparatus 1 as described above and receiving an input of a manipulation by a user to the present system.

Under this condition, according to this embodiment, an AV system includes a combination of one base station apparatus 1 and multiple monitor apparatus 2, as described above. Furthermore, for example, in order to control the base station apparatus 1 from the monitor apparatus 2, each of the multiple monitor apparatus 2 can request image information (video signal) independently. More specifically, for example, the multiple monitor apparatus 2 can request images of television broadcasts of different channels from each other. In response to such a request, the base station apparatus 1 transmits multiple pieces of image information (video signals) such that the multiple monitor apparatus can display the respective requested images with a construction, which will be described later.

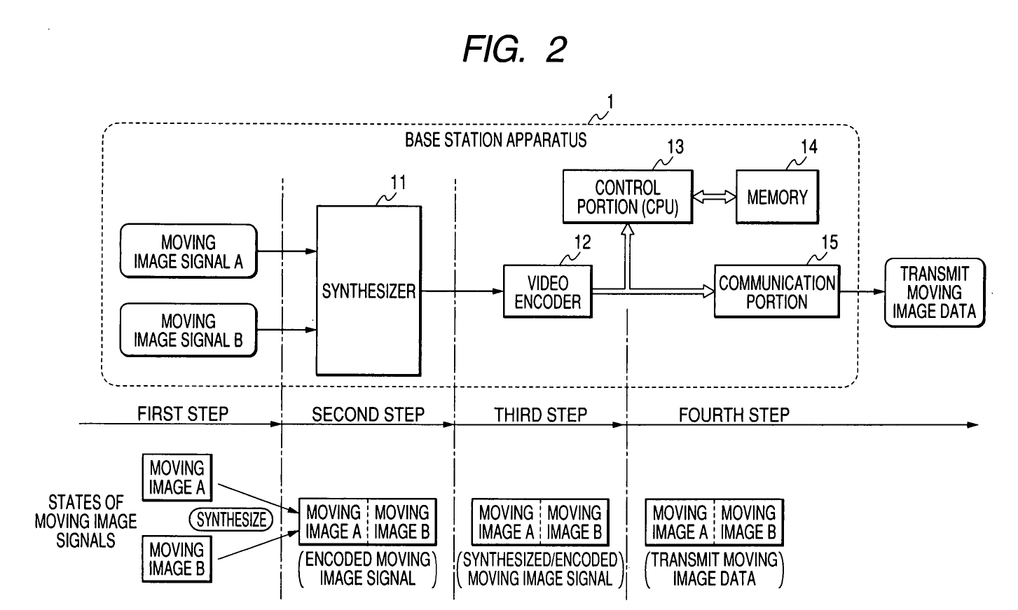

Notably, while two monitor apparatus 2 are shown in FIG. 2, the number of monitor apparatus 2 in the AV system is not limited in particular according to a concept of the invention as being apparent from the description below.

FIG. 2 is a block diagram showing a construction example for transmitting image information (that is, a video signal: moving image signal) from the base station apparatus 1 according to this embodiment. FIG. 2 schematically shows a state of a moving image signal in a processing flow (steps) in components shown in the block diagram. Here, the state of the moving image signal is a display state resulting from the display of the moving image signal.

FIG. 2 shows a case that the base station apparatus 1 obtains a moving image signal (video signal) A and a moving image signal (video signal) B as image information to be transmitted to the monitor apparatus 2. The image information serving as these moving image signals may be video signals of television broadcasts of different channels. In the processing flow in the base station apparatus 1, moving images A and B corresponding to the moving image signal A and moving image signal B are separate from each other, which have independent contents data from each other in a moving image state in a first step shown in FIG. 2, where the first step is a step that the moving image signal A and moving image signal B are obtained.

In reality, in order to simultaneously obtain video signals of television broadcasts of multiple different channels in the above-described manner, multiple tuners for television broadcasts may be provided for the base station apparatus 1.

Furthermore, as an external AV machine, a machine including a television broadcast tuner may be connected to the base station apparatus 1. Thus, a video signal of a channel selected to receive by a television tuner of the base station apparatus 1 and a video signal of another channel selected to receive by the external AV machine side may be input to and obtained by the base station apparatus 1. Apparently, video signals of channels selected to receive by multiple external AV machines may be input and obtained without a tuner of the base station apparatus 1.

The moving image signals A and B obtained in this way are input to a synthesizer 11. In processing in a second step, the synthesizer 11 performs synthesizing processing on input multiple moving image signals and outputs the result as one moving image signal (synthesized moving image signal). In FIG. 2, the synthesizer 11 performs synthesizing processing on the input two moving image signals A and B and creates a synthesized moving image signal thereby. Thus, the state of the moving image signal corresponding to the synthesized moving image signal is a state that the moving image A and moving image B are synthesized on one screen as shown in FIG. 2, for example. In FIG. 2, when two moving image signals are synthesized, the result of the synthesis processing is shown in which moving image signals to be synthesized are arranged horizontally.

The maximum number of moving image signals that the synthesizer 11 can input should not be limited in particular. The synthesizer 11 itself may perform synthesizing processing by performing analog signal processing or digital signal processing. For example, when the moving image signals obtained in the first step are analog signals in an actual construction of the base station apparatus 1, the synthesizer 11 may synthesize the moving image signals by performing analog signal processing thereon. When the moving image signals obtained in the first step are digital signals, the synthesizer 11 may synthesize the moving image signals by performing digital signal processing thereon.

Then, the synthesized moving image signal resulting from synthesizing processing by the synthesizer 11 is input to the video encoder 12.

In the third step, the video encoder 12 compresses and encodes the input moving image signal in accordance with a predetermined encoding technique and creates and outputs the encoded moving image signal. The encoded moving image signal to be output is a digital signal. When a moving image signal to be input is an analog signal, the video encoder 12 performs A/D conversion processing first and then encoding processing. In this case, the video decoder 12 outputs one encoded moving image signal corresponding to an input of one moving image signal, which is similar to a conventional case.

The compressing and encoding technique with which the video encoder 12 is compliant is not limited in particular but presently may be a technique based on Moving Picture Experts Group (MPEG) or H.264, for example.

In the third step, the video encoder 12 performs processing for compressing and encoding even on a synthesized moving image signal input from the synthesizer 11 in the same manner as that for a general moving image signal and outputs the result as a compressed and encoded moving image signal. The data of an encoded moving image signal resulting from the encoding of a synthesized moving image signal by the video encoder 12 is a synthesized/encoded moving image signal in this embodiment. In the case in FIG. 2, the synthesized/encoded moving image signal is one resulting from encoding of the synthesized moving image signal in which the moving image signals A and B are synthesized. Thus, in FIG. 2, the image corresponding to the synthesized/encoded moving image signal obtained by the third step has the moving image A and moving image B synthesized on one screen as shown in FIG. 2.

The data of an encoded moving image signal output from the video encoder 12 is transferred to, written in and temporarily stored in the memory portion 14 under the control of the control portion 13. The control portion 13 loads and transfers and input the data of the encoded moving image signal temporarily stored in the memory portion 14 in required timing to the communication portion 15. The timing for loading data of an encoded moving image signal by the control portion 13 here is defined such that the data of the encoded moving image signal can be continuously output and reconstructed to an image in a monitor apparatus having received the data of the encoded moving image signal, for example.

The control portion 13 adopts a construction as a microcomputer including a central processing unit (CPU), for example, and performs control in a base station apparatus 1 including moving image signal processing shown in FIG. 2.

In this case, the communication portion 15 performs communication processing based on a predetermined communication protocol adopted to radio wave communication according to this embodiment. For example, the communication protocol for the radio wave communication of this embodiment may be Transmission Control Protocol/Internet Protocol (TCP/IP). That is, the radio wave communication adopts the same communication protocol as that of the Internet. The TCP/IP can be applied easily since it is widely spread over the Internet.

For example, in order to allow exchanges based on TCP/IP, processing such as packetizing and then predetermined carrier modulation is performed on data to be transmitted, and the result is transmitted as radio waves. In the receiving processing, transmit information transmitted as radio waves is received and is demodulated to information in packet. Then, processing for unpacketizing is performed thereon based on the communication protocol, TCP/IP, so that real data of video/audio information such as a command can be obtained.

In the fourth step, the communication portion 15 performs the same communication processing on data of an encoded moving image signal transferred from the memory 14 under the control portion 13 as described above so that the data can be transmitted as transmit moving image data to the monitor apparatus 2 defined as a destination by radio wave communication.

Then, in the example in FIG. 2, since an encoded moving image signal output from the video encoder 12 is a synthesized/encoded moving image signal, transmit moving image data to be transmitted from the communication portion 15 is a synthesized/encoded moving image signal. In FIG. 2, an image corresponding to the transmit moving image data to be transmitted in the fourth step also results in a state in which the moving image A and moving image B are synthesized on one screen as shown in FIG. 2.

Thus, in order to transmit multiple different pieces of moving image information to multiple monitor apparatus 2, the base station apparatus 1 of this embodiment synthesizes multiple moving image signals corresponding to the multiple pieces of moving image information and creates one moving image signal (synthesized moving image signal). Then, the synthesized moving image signal is compressed and encoded and is transmitted in the same manner as that for a general moving image signal.

A synthesized/encoded moving image signal as transmit moving image data is simultaneously transmitted from the base station apparatus 1 of this embodiment to multiple monitor apparatus 2. In order to simultaneously transmit transmit moving image data to multiple monitor apparatus 2 in this way, the communication with the monitor apparatus 2 is implemented through broadcasting or multicasting.

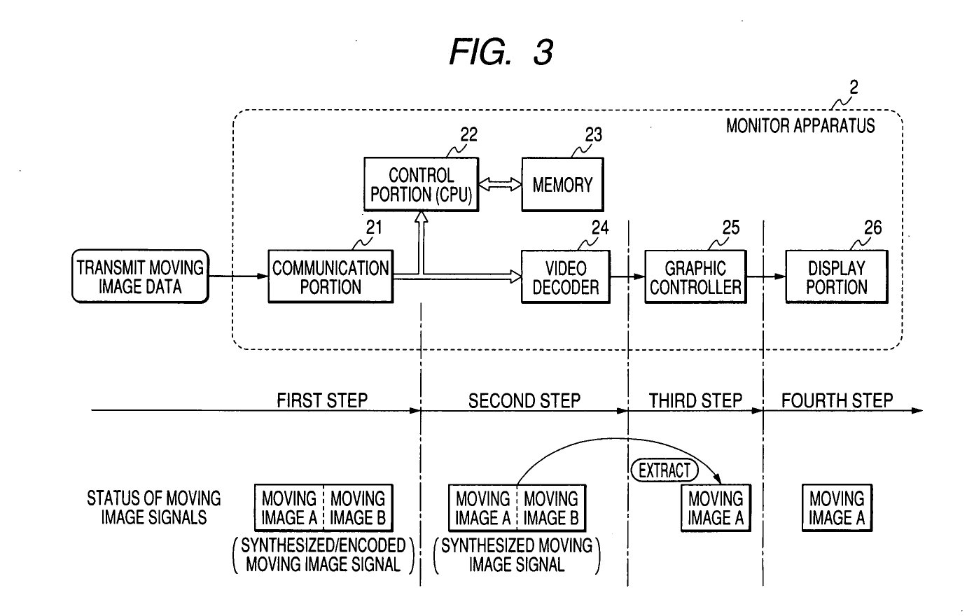

FIG. 3 is a block diagram showing a construction example for transmitting image information (video signal: moving image signal) to the monitor apparatus 2 of this embodiment. FIG. 3 also schematically shows a state of a moving image signal in a processing flow (steps) in components shown in the block diagram. Here, the state of the moving image signal is a display state resulting from the display of the moving image signal.

First of all, transmit moving image data transmitted from the base station apparatus 1 is received and demodulated by a communication portion 21 in the monitor apparatus 2. The construction of the communication portion 21 may have the same construction as that of the communication portion 15 of the base station apparatus 1 as described above.

Receiving and demodulating transmit moving image data by the communication portion 21 results in data of an encoded moving image signal. A control portion 22 writes and temporarily stores to hold in a memory 23 the data of the encoded moving image signal obtained by the communication portion 21. Then, in predetermined timing, data of an encoded moving image signal stored in the memory 23 is loaded and is transferred to a video decoder 24. The processing up to this point is a first step in the monitor apparatus 2.

The control portion 22 also has a construction as a microcomputer including a CPU, for example, and performs control in the monitor apparatus 2 including moving image signal processing shown in FIG. 3. The timing for transferring data of an encoded moving image signal to the video decoder 24 by the control portion 22 is defined such that the continuity of moving image signals decoded and output by the video decoder 24 can be maintained. As a result, the image displayed and output by a display portion 26 finally does not have an irregularity due to discontinuity, for example.

In FIG. 3, data of an encoded moving image signal to be transferred to the video decoder 24 by the first step is data of a synthesized/encoded moving image signal in which a moving image signal A and a moving image signal B are synthesized. Thus, the image corresponding to a moving image signal in the first step also has a state in which the moving image A and the moving image B are synthesized.

The video decoder 24 receives an input of data of an encoded moving image signal transferred under the control of the control portion 22 as described above, performs decoding processing thereon corresponding to the encoding technique in the video encoder 12 and creates and outputs a moving image signal expanded by the decoding. The decoding processing by the video decoder 24 is the second step.

In the second step in FIG. 3, a synthesized/encoded moving image signal in which moving image signals A and B are synthesized is input to the video decoder 24, and the second step (that is, the decoding processing) results in a synthesized moving image signal in which the moving image signals A and B are synthesized. Also in the synthesized moving image signal regarded as an image, the moving image A and moving image B are synthesized as shown in FIG. 3.

A moving image signal resulting from the decoding by the video decoder 24 is input to a graphic controller 25. The graphic controller 25 can perform image processing on the input moving image signal first so as to obtain a required image display form. For example, a moving image signal for displaying an image part, which is a part of the entire image that is the input moving image signal, can be created from the input original moving image signal. Here, processing such as pixel interpolation and pixel thinning-out is performed thereon so that the resolution (pixel size) of the original moving image signal can be changed.

In this case, the graphic controller 25 also performs signal processing for displaying text such as a channel number and an input source over the original moving image data, that is, for on-screen display.

When a moving image signal input from the video decoder 24 is a synthesized moving image signal, the graphic controller 25 performs image processing for extracting a moving image signal to be displayed by the monitor apparatus 2 from multiple moving image signals included in the input synthesized moving image signal. The image processing is the third step.

In order to display a moving image signal A by the monitor apparatus 2 of a synthesized moving image signal in which the moving image signals A and B are synthesized, which is input to the graphic controller 25 as shown in FIG. 3, the moving image signal A is extracted from the synthesized moving image signal by the third step. Therefore, the image corresponding to the resulting moving image signal here is only the moving image A as shown in FIG. 3.

Then, the graphic controller 25 creates a moving image signal (video signal) to be displayed on the display portion 26 in this way and drives the display portion 26 to display the image of the moving image signal on the display portion 26 as an image. Thus, the display device (such as an LCD) serving as the display portion 26 performs image display. This is the fourth step in the monitor apparatus 2.

In the case in FIG. 3, in the fourth step, a signal on which the driving of the display portion 26 is based is the moving image signal A extracted from the synthesized moving image signal as described above, and the image corresponding thereto is therefore the moving image A. This means that, as an image as a result of the fourth step, the moving image A is actually displayed by the display portion 26.

Under these constructions of the base station apparatus 1 and monitor apparatus 2, the graphic controller 25 in the monitor apparatus 2 can have the function of extracting a required moving image signal from a synthesized moving image signal including multiple moving image signals. In accordance therewith, the base station apparatus 1 only needs to synthesize and transmit multiple moving image signals, which are different kinds of contents, simultaneously to multiple monitor apparatus. According to this embodiment, the data of the contents of moving image signals is compressed and encoded for a smaller data size. In the processing steps, multiple moving image signals are synthesized and one moving image signal (synthesized moving image signal) is created thereby first. Then, the synthesized moving image signal is encoded.

Thus, the base station apparatus 1 always needs to perform encoding processing on one moving image signal only. In other words, irrespective of the number of moving images to be transmitted to the monitor apparatus 2, one signal processing channel is required for encoding processing. Applying the fact to the construction in FIG. 2, one video encoder is required in the base station apparatus 1, that is, the video encoder 12 is only required even when the maximum connectable number (the number of moving images to be transmitted) of a monitor apparatus increases.

Thus, even in the construction that the base station apparatus 1 can transmit data of different moving images to multiple monitor apparatus simultaneously, one video encoder is only required, and even when the maximum connectable number of monitor apparatus increases, no additional video encoders are required therefor. Therefore, the manufacturing costs can be reduced. Furthermore, since the size of the circuit is not increased, increases in size of the circuit substrate of the base station apparatus and in size and weight of the entire apparatus can be avoided. Furthermore, in a construction that the processing function of the video encoder is implemented by processing in software to be executed by the control portion (CPU) 13 in accordance with a program, the encoding processing to be performed by the control portion 13 is always for one moving image signal. Therefore, irrespective of the increase in number of moving image signals to be synthesized, a load for encoding to be put on the control portion is not increased.

Furthermore, apparently from the description with reference to FIG. 2, the processing for encoding a synthesized moving image signal by means of the video encoder 12 and transmitting the result by means of the communication portion 15 is the same as the processing to be performed on one general moving image signal. This is because a synthesized moving image signal itself must be handled as one moving image signal. Therefore, the control for traffic by the control portion 13 here, that is, the timing control for writing/reading synthesized/encoded moving image signal data to/from the memory 14, and the timing control for transmission to the communication portion 15 are similar to those for transmitting one general moving image signal. As a result, when multiple pieces of moving image information are transmitted, the load on the CPU in the control portion 13 is not increased, and the reliability in operation is not lost.

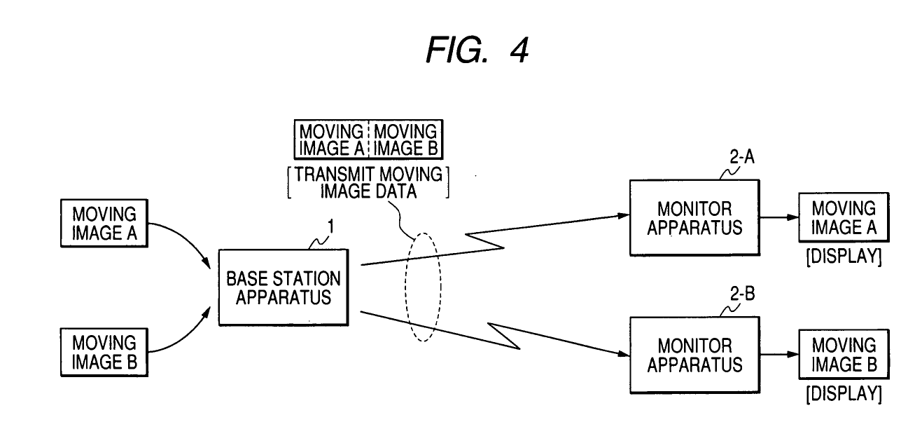

Next, an operational example for an application of an AV system including a base station apparatus 1 and multiple monitor apparatus 2 under the construction as described above will be described with reference to FIGS. 4 to 8.

As shown in FIG. 4, an operation is performed in the AV system here in which the base station apparatus 1 obtains two moving image signals of moving images A and B as contents and simultaneously transmits a synthesized/encoded moving image signal resulting from the synthesis and/or encoding of the moving image signals of the moving images A and B to monitor apparatus 2-A and 2-B as transmit moving image data by broadcasting or multicasting. In response thereto, the monitor apparatus 2-A extracts and displays the moving image signal of the moving image A from the data of the synthesized moving image signal resulting from the decoding of the received transmit moving image data. The monitor apparatus 2-B extracts and displays the moving image signal of the moving image B from the data of the synthesized moving image signal resulting from the decoding of the received transmit moving image data.

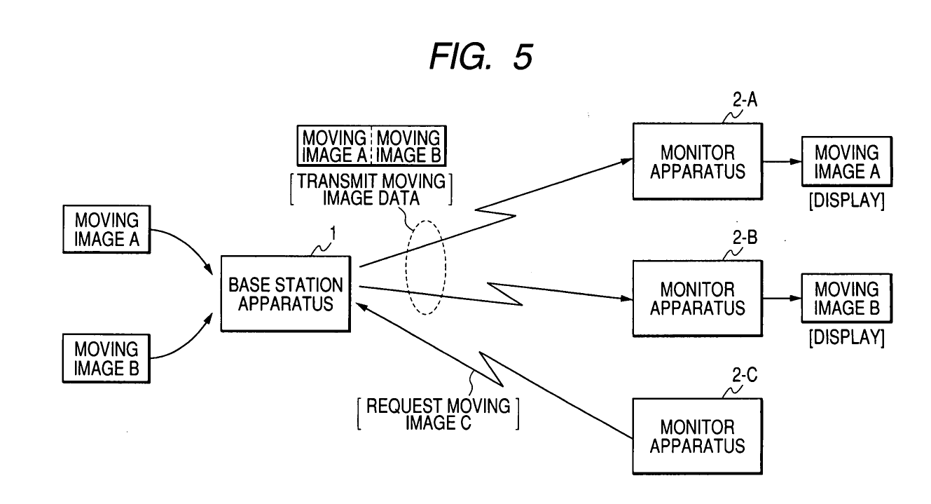

Then, from this state, another monitor apparatus 2-C in a communicable zone of the AV system may transmit a command requesting a moving image C to the base station apparatus 1 as shown in FIG. 5. The moving image C is different contents from those of the moving images A and B that the base station apparatus 1 transmits as transmit moving image data (synthesized/encoded moving image signal) up to this point. That is, the monitor apparatus 2-C requests to transmit a new moving image, which has not been transmitted yet.

In response to the request for the moving image C, the base station apparatus 1 newly obtains the moving image signal of the moving image C as shown in FIG. 6. Then, the moving image signal of the moving image C is also synthesized with the moving image signals of the moving image A and moving image B up to that point, whereby a synthesized moving image signal thereof is obtained. Then, the synthesized moving image signal is encoded and is transmitted to the monitor apparatus 2-A, 2-B and 2-C as transmit moving image data by broadcasting or multicasting. Considering the resulting synthesized moving image signal as an image, the moving image signal may be an arrangement of the moving images A, B and C in one screen area as schematically shown in FIG. 6.

Then, the monitor apparatus 2-A, 2-B and 2-C receive the transmitted transmit moving image data and obtain the synthesized moving image signal resulting from the synthesis of the moving images A, B and C. Then, in the same manner, the monitor apparatus 2-A extracts and display-outputs the moving image signal of the moving image A from the synthesized moving image signal. The monitor apparatus 2-B extracts and display-outputs the moving image signal of the moving image B from the synthesized moving image signal. The monitor apparatus 2-C extracts and display-outputs the moving image signal of the moving image C from the synthesized moving image signal. That is, the monitor apparatus 2-C can receive and display-output the supply of the requested moving image C.

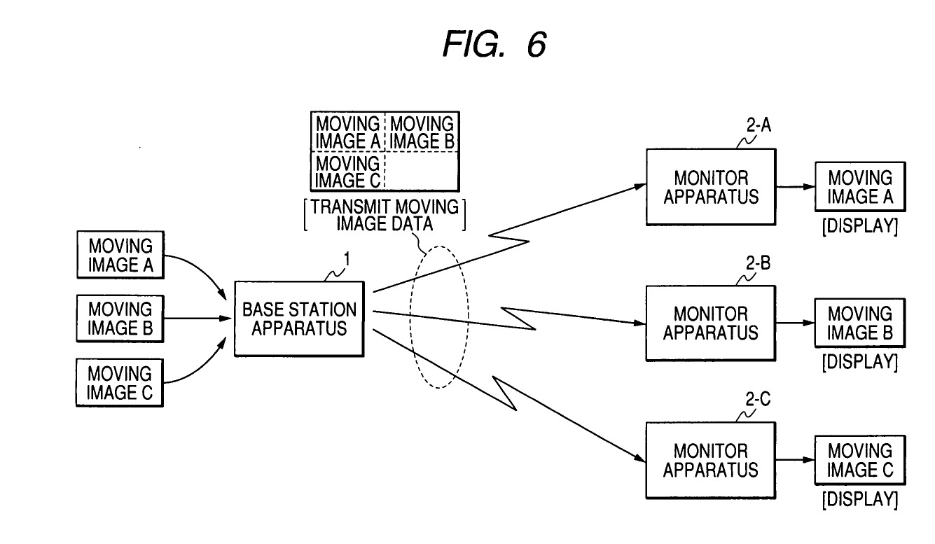

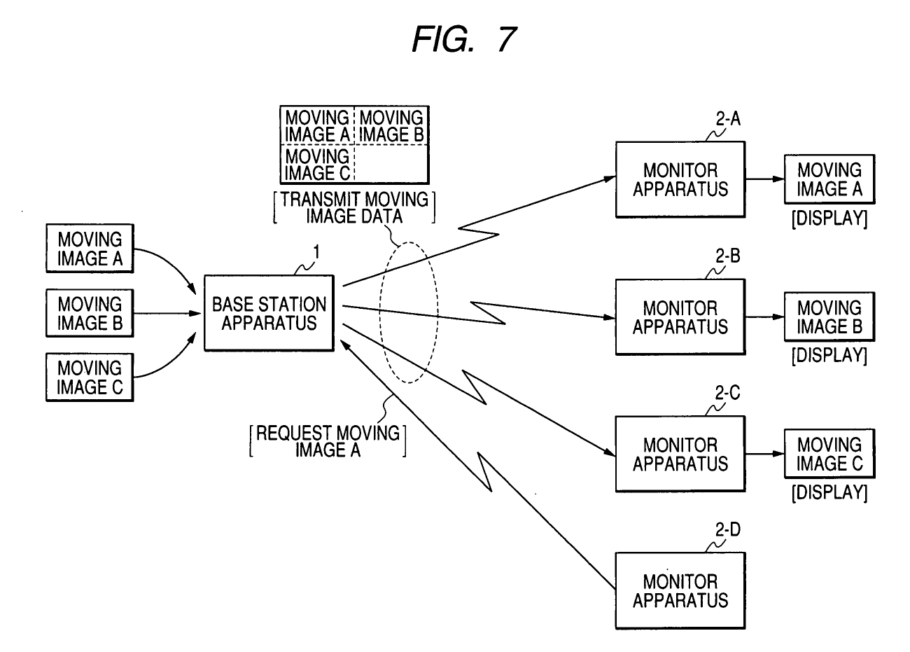

Then, from the operation state shown in FIG. 6, another monitor apparatus 2-D may further transmit a command for requesting the moving image A to the base station apparatus 1 as shown in FIG. 7. Here, the moving image A requested by the monitor apparatus 2-D is the same contents as the one received, decoded, extracted and displayed by the monitor apparatus 2-A. That is, the moving image A requested by the monitor apparatus 2-D has been synthesized to the synthesized moving image signal and transmitted from the base station apparatus 1.

In response to the request from the monitor apparatus 2-D, the base station apparatus 1 transmits transmit moving image data, which is the synthesized moving image signal resulting from the synthesis of the moving image signals corresponding to the moving images A, B and C, respectively, in the same manner as above. That is, in this case, the transmit moving image data is transmitted continuously without any change in the contents in FIG. 6.

Also in this case, the monitor apparatus 2-A, 2-B, 2-C and 2-D receive and decode the transmit moving image data transmitted simultaneously and obtain the synthesized moving image signal resulting from the synthesis of the moving images A, B and C.

In the same manner as above, the monitor apparatus 2-A extracts and displays the moving image signal of the moving image A from the synthesized moving image signal. The monitor apparatus 2-B extracts and displays the moving image signal of the moving image B from the synthesized moving image signal. The monitor apparatus 2-C extracts and displays the moving image signal of the moving image C from the synthesized moving image signal. Then, the monitor apparatus 2-D also extracts and displays the moving image signal of the same moving image A as that of the monitor apparatus 2-A from the synthesized moving image signal. That is, the monitor apparatus 2-D can receive and display the supply of the requested moving image A.

Here, as shown in FIGS. 5 and 6, in response to a request for a new moving image from a monitor apparatus 2, the base station apparatus 1 newly obtains a moving image signal as the requested moving image, additionally synthesizes the moving image signal to a synthesized moving image signal and transmits the result.

On the other hand, as shown in FIGS. 7 and 8, when the moving image requested from a monitor apparatus 2 is one already synthesized to a synthesized moving image signal and being transmitted, the base station apparatus 1 does not newly add the requested moving image to the synthesized moving image signal. In this embodiment, information to be simultaneously transmitted to multiple monitor apparatus by broadcasting or multicasting is a synthesized moving image signal resulting from the synthesis of all moving image signals requested by the monitor apparatus. Therefore, when a same moving image is required, the multiple monitor apparatus only needs to extract the same moving image signal included in the synthesized moving image signal. That is, since the same information resource can be shared, synthesizing the same moving image signal to the synthesized moving image signal is not required repeatedly.

Thus, even when the number of monitor apparatus requesting moving images increases and when multiple monitor apparatus request a same moving image, an increase in number of moving image signals to be synthesized to a synthesized moving image signal can be prevented. Thus, the load of the image synthesizing processing is not increased aimlessly. This is a factor for suppressing an increase in size of the construction of the synthesizer 11. Since the number of moving image signals to be synthesized to a synthesized moving image signal is not increased, the load of the extracting processing by the monitor apparatus can be light. When the image signal processing to be performed by the synthesizer 11 and the extracting processing by the monitor apparatus 2 are performed in software, the load of the processing is not increased aimlessly. Thus, the load of the processing on the control portions 13 and 22 performing the processing can be decreased.

The system and construction will be described later for properly extracting a required moving image signal from a synthesized moving image signal received and obtained by the monitor apparatus 2 as shown in FIGS. 4 to 8.

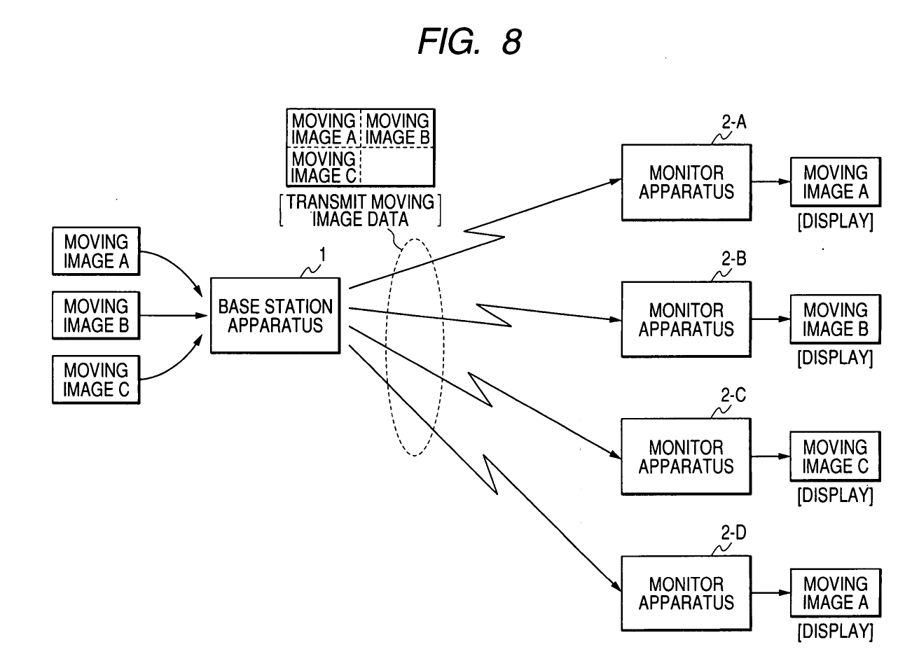

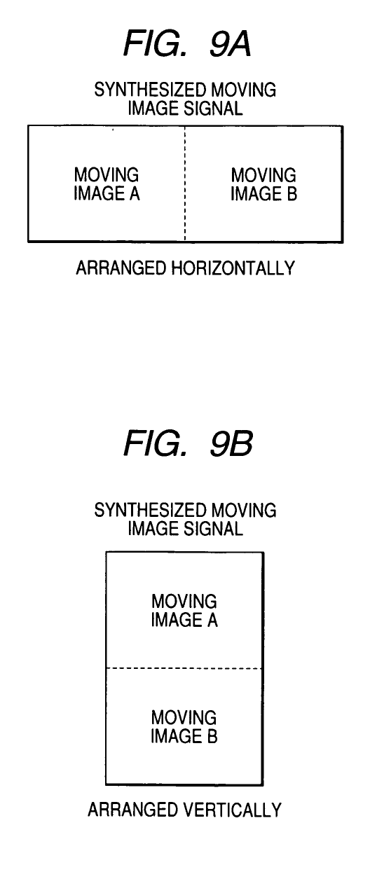

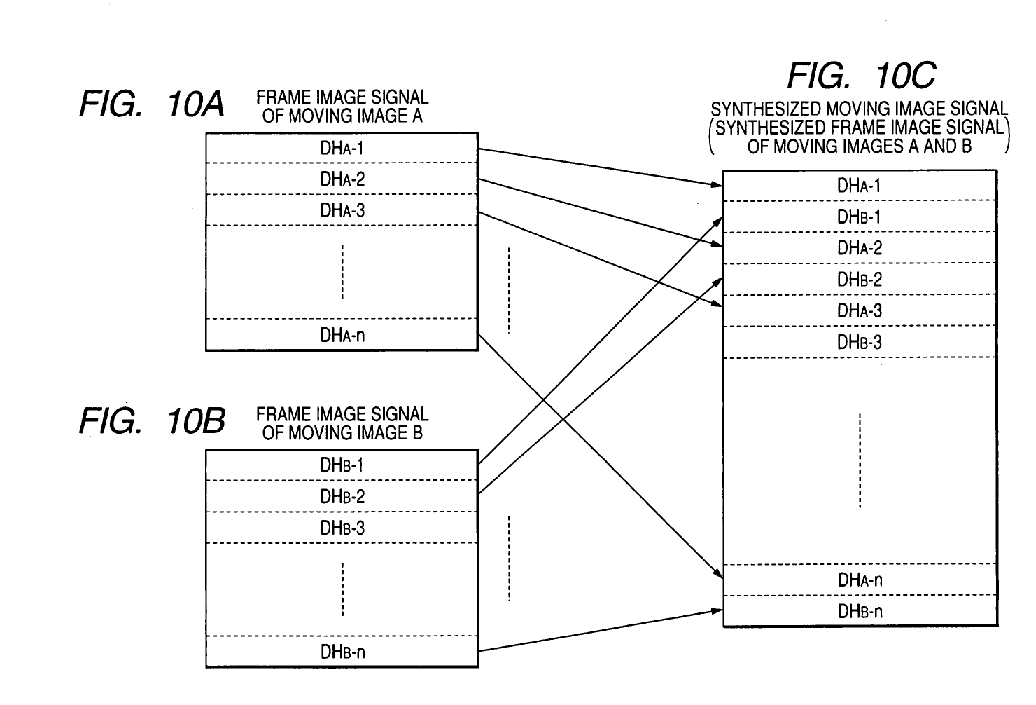

Here, the synthesizer 11 of the base station apparatus 1 synthesizes moving image signals to a synthesized moving image signal as shown in FIGS. 9A to 10C, for example.

FIGS. 9A and 9B schematically show displayed images of synthesized moving image signals. FIGS. 9A and 9B show examples in which moving image signals corresponding to two of the moving images A and B are synthesized for simple description.

First of all, FIG. 9A shows the same state of moving image signal as the one shown in FIGS. 2 to 5 described above. In other words, synthesizing processing is performed such that the resulting synthesized moving image signal corresponds to moving image signals horizontally arranged in one screen. For the processing, video signals are created such that horizontal lines at the same position in moving image signals to be synthesized can be arranged in series for each horizontal line of a synthesized moving image signal.

Alternatively, as shown in FIG. 9B, synthesizing processing may be performed for a synthesized moving image signal in which moving images to be synthesized correspond to images arranged vertically in one screen. In order to create such a synthesized moving image signal, image signals for one screen may be created continuously by inputting signals from the first horizontal line to the last horizontal line of one moving image signal and then inputting signals from the first horizontal line to the last horizontal line of a moving image signal to be positioned thereunder.

As shown in FIGS. 9A and 9B, when the number of moving image signals to be synthesized is equal to or lower than a predetermined number, the moving images may be synthesized in a manner that the moving images are arranged horizontally or vertically. When the number of moving image signals to be synthesized is higher than the predetermined number, the moving images may be synthesized in a manner that the images are arranged in a matrix form both in the horizontal and vertical directions under a predetermined rule. For example, the transmit moving image data resulting from the synthesis of the moving images A, B and C shown in FIGS. 6 to 8 has such a synthesis pattern.

A synthesis pattern as illustrated in FIGS. 10A to 10C may be also adopted as a variation of the synthesis resulting in a vertical arrangement of moving images. FIGS. 10A to 10C also show an example that two moving image signals corresponding to moving images A and B are synthesized.

FIGS. 10A and 10B show frame image signals including horizontal line signals of moving image signals of the moving images A and B, respectively. The frame image signal of the moving image A includes line signals in the first horizontal line DHA-1 through the last horizontal line DHA-n while the frame image signal of the moving image B includes line signals in the first horizontal line DHB-1 through the last horizontal line DHB-n.

In order to synthesize the moving image signals of the moving images A and B and create a synthesized image signal thereof, the moving image signals from the first horizontal line through the last line are arranged in a manner that horizontal lines DHA-1→DHB-1→DHA-2→DHB-2→DHA-3→DHB-3→ . . . →DHA-n→DHB-n as shown in FIG. 10C. In other words, in this case, the horizontal lines of the frame image signals of the moving images A and B are synthesized alternately to one frame image signal, which is a synthesized moving image signal. The synthesizing technique shown in FIGS. 10A to 10C performs synthesis in horizontal line of video signals of moving images to be synthesized while the synthesizing technique shown in FIGS. 9A and 9B performs synthesis in moving images to be synthesized, for example.

One of these techniques can be adopted also when three or more moving images are to be synthesized. For example, when a moving image C is to be synthesized in addition to the moving images A and B and when a frame image signal of the moving image C includes the first horizontal line DHC-1 through the last line DHC-n, the synthesized frame image signal serving as a synthesized moving image signal thereof may be arranged in a manner of horizontal lines DHA-1→DHB-1→DHC-1→-DHA-2→DHB-2→DHC-2→DHA-3→DHB-3→DHC-3→ . . . →DHA-n→DHB-n→DHC-n, for example.

Notably, while, in the example described with reference to FIGS. 10A to 10C, one horizontal line of moving image signals to be synthesized is sequentially assigned to one horizontal line of the synthesized moving image signal, the synthesis basically only needs to be performed in horizontal line. Therefore, multiple horizontal lines of a moving image signal to be synthesized may be handled as one video signal part, and the synthesis may be performed in video signal parts. Furthermore, while, in FIGS. 10A to 10C, frame image signals of one moving image among frame image signals of a synthesized moving image has the same arrangement of horizontal lines as that of the frame image signals of the original moving image, synthesis may be performed by scrambling horizontal lines of frame image signals of the original moving image under a predetermined rule and then assigning the scrambled horizontal lines to horizontal lines of frame image signals of the synthesized moving image.

Apparently from FIGS. 5 and 6, the number of moving image signals to be synthesized to and included in a synthesized moving image signal to be transmitted as transmit moving image data is dynamically variable in accordance with a request from the monitor apparatus 2 side, for example, according to this embodiment. Thus, according to this embodiment, the encoding rate (such as the compression rate) for compressing and encoding the synthesized moving image signal may be changed in accordance with the number of moving image signals synthesized to and included in the synthesized moving image signal as described later.

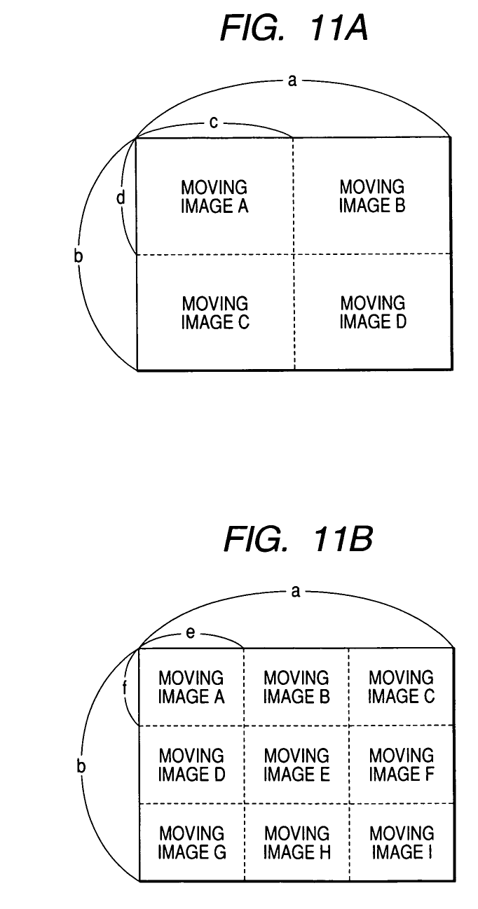

Here, as shown in FIG. 11A, the maximum resolution (that is, the number of pixels) processable by the base station apparatus 1 of a frame image serving as a moving image signal is a×b, where the horizontal resolution (that is, the number of horizontal pixels) is a, and the vertical resolution (that is, the number of vertical pixels) is b.

As described above, since the base station apparatus 1 also handles a synthesized moving image signal as one moving image signal, the maximum resolution of a synthesized moving image signal is also a×b. Then, in order to synthesize two to four moving images into a synthesized moving image signal here, the image size corresponding to the maximum resolution of a×b is defined as a synthesized area and a resolution of c×d is defined for each moving image, where c is a horizontal resolution and d is a vertical resolution, as shown in FIG. 11A.

For simple description, the horizontal resolution a of a synthesized area and the horizontal resolution c of a moving image to be synthesized has a relationship of ½a=c here. The vertical resolution b of a synthesized area and the vertical resolution c of a moving image to be synthesized also has a relationship of ½b=d.

A required number under four of moving image signals having a resolution defined as described above may be synthesized by assigning the moving image signals to the synthesized area in a matrix arrangement pattern. In this case, as indicated by moving images A, B, C and D in FIG. 11A, moving image signals having a resolution of c×d may be assigned and synthesized to a synthesized area having a resolution of a×b.

As shown in FIG. 11A, another moving image signal may be synthesized from the state that four moving image signals are synthesized into a synthesized moving image signal. However, in this case, another moving image signal cannot be added and synthesized with the resolution of c×d shown in FIG. 11A.

Accordingly, in this case, a smaller resolution of e×f than the resolution of c×d can be defined as the resolution (horizontal resolution×vertical resolution) of the moving image signal to be synthesized, as shown in FIG. 11B.

In FIG. 11B, the resolution of e×f of moving image signal to be synthesized and the resolution of a×b of a synthesized area have relationships of ⅓a=e and ⅓b=f. Thus, as indicated by moving images A to I in FIG. 11B, nine moving image signals to the maximum can be assigned and synthesized to a matrix arrangement pattern.

By reducing the resolution of moving image signals in accordance with an increase in number of moving image signals to be synthesized, all of moving image signals to be synthesized can be assigned and synthesized to a limited synthesized area.

However, as well known, a decrease in resolution of an image signal deteriorates the quality for displaying the image of the image signal. Therefore, when the resolution of moving image signals is decreased in accordance with the number of moving images to be synthesized in the above-described manner, the quality of an image displayed by the monitor apparatus 2 deteriorates.

According to this embodiment, in order to compensate for the decrease in quality, the encoding rate (such as the compression rate) for encoding a synthesized moving image signal resulting from the synthesis of moving image signals by means of the video encoder 12 may be reduced in accordance with a decrease in resolution of the moving image signals in accordance with the number of moving images to be synthesized. Increasing the encoding rate even with the same compression/encoding technique as well known results in a smaller data rate but in low reconstruction quality. Conversely, decreasing the encoding rate results in a large data rate but in high reconstruction quality.

The actual value of an encoding rate may be defined in consideration of a relationship between the maximum resolution of an actual synthesized area and a resolution defined for moving image signals to be synthesized and quality of a moving image actually displayed by the monitor apparatus 2.

A change in an encoding rate in accordance with the number of moving images to be synthesized may be applied to the synthesis in horizontal lines as shown in FIGS. 10A to 10C.

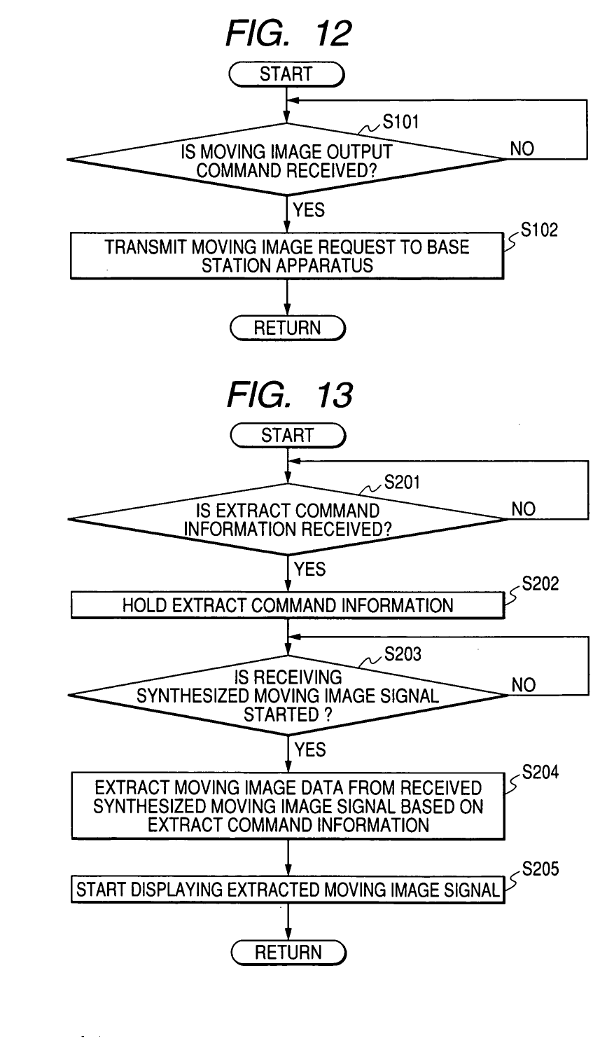

Next, with reference to FIGS. 12 to 14, a processing operation to be performed in the base station apparatus 1 and monitor apparatus 2 will be described in accordance with the operation of an AV system according to this embodiment as described above.

In the AV system of this embodiment, in order to newly display a moving image of some contents by the monitor apparatus 2, the moving image signal of the contents must be transmitted from the base station apparatus 1. Therefore, the monitor apparatus 2 must select a piece of contents, that is a moving image, and then request the moving image signal to the base station apparatus 1, as illustrated as operations of the monitor apparatus 2-C in FIG. 5 and monitor apparatus 2-D in FIG. 7. FIG. 12 shows processing steps thereof to be performed by the control portion 22 shown in FIG. 3 in accordance with a program.

In step S101, the processing shown in FIG. 12 waits for a receipt of a command for displaying a moving image on the monitor apparatus 2 first. When a user selects a desired piece of contents by performing an operation on the monitor apparatus 2, for example, and performs an operation for displaying an image of the contents, a command for outputting the moving image is generated in response thereto. More specifically, a user may select a desired channel and perform an operation for displaying an image of a television broadcast on the monitor apparatus 2. Then, a command is generated for selecting and displaying a moving image of the selected channel as the contents.

In this way, when a command for outputting a moving image is generated, the processing moves from step S101 to step S102.

In step S102, control processing is performed, in response to the moving image display command as described above, for selecting a base station apparatus 1 to be a destination and transmitting a command (moving image request command) for requesting the transmission of a moving image. Here, information of the generated command for displaying a moving image includes information selecting contents (moving image signal) to be displayed, and the moving image request command includes, as contents data, information selecting contents (moving image signal) as described above for contents (moving image signal) to be transmitted.

In the control processing in step S102, the communication portion 21 transmits the moving image request command to the base station apparatus 1 serving as the destination.

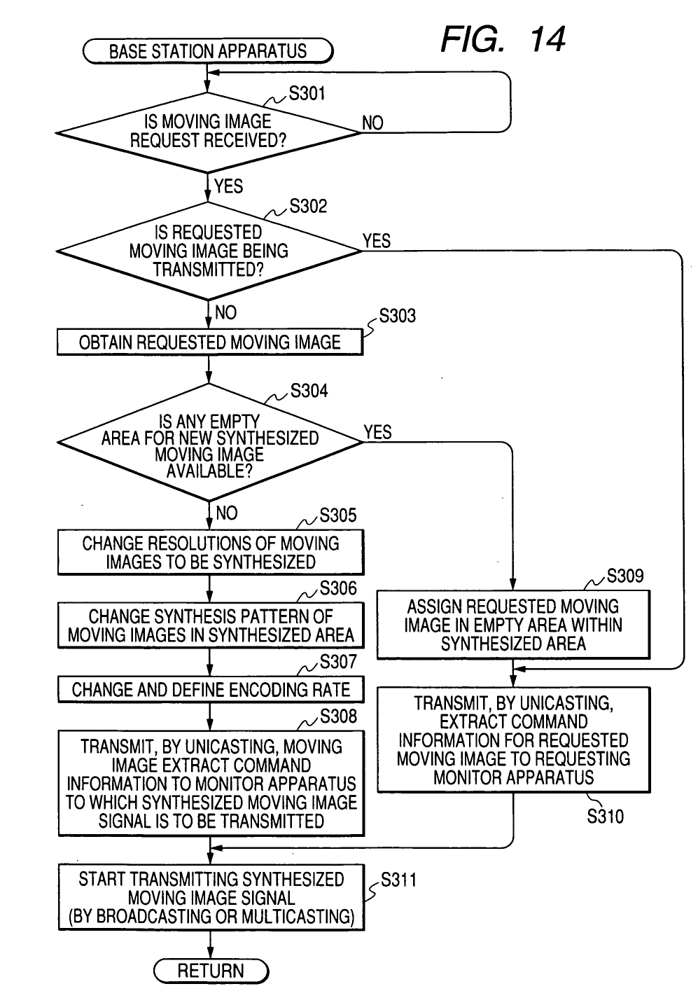

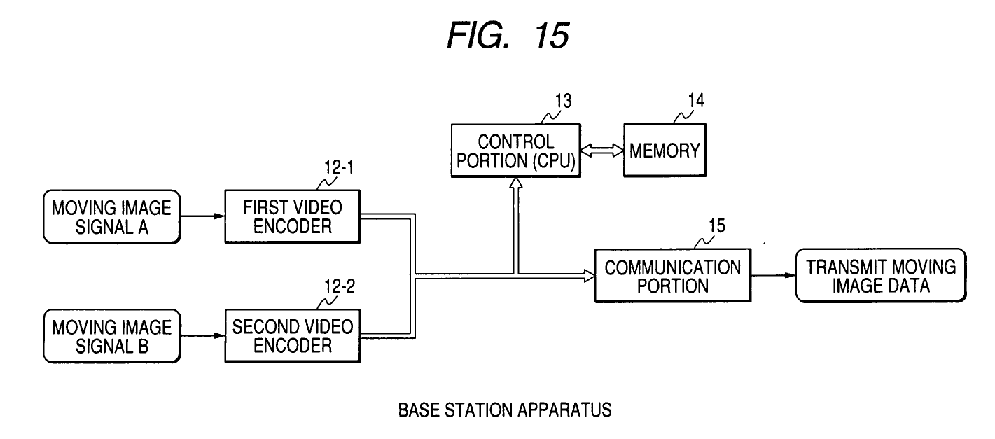

FIG. 14 shows processing to be performed by the base station apparatus 1 in response to the moving image request command. The processing shown in FIG. 14 is performed by the control portion 13 shown in FIG. 2 in accordance with a program. Notably, FIG. 13 shows processing on the monitor apparatus 2 side in accordance with extract command information to be transmitted by the processing shown in FIG. 14, which will be described later.

First of all, in step S301, the base station apparatus 1 side waits for a receipt of a moving image request command transmitted by one monitor apparatus included in the AV system, and the processing moves to step S302 and subsequent steps when a receipt of the moving image request command is identified.

In step S302, contents of a moving image selected by the command is identified with reference to the information of the received moving image request command. It is determined whether the moving image signal corresponding to the identified contents is currently being transmitted as transmit moving image data.

If it is determined in step S302 that the moving image signal selected by the moving image request command received this time is being transmitted, which is the positive result, the processing moves to step S310, which will be described later. On the other hand, if it is determined that the moving image signal selected by the moving image request command received this time is not being transmitted currently, which is the negative result, the processing moves to step S303.

If the negative determination result is obtained in step S302, a moving image signal selected by the moving image request command received this time in step S301 must be transmitted by adding the moving image signal to transmit moving image data having been transmitted up to this point. The processing is performed in step S303 and subsequent steps.

Accordingly, in step S303, the contents of the moving image signal requested by the command is identified first with reference to information of the moving image request command received this time. Then, control processing is performed for obtaining contents, that is, the moving image signal requested by the command. When the requested contents is an image of a predetermined channel of a television broadcast, for example, control is performed for switching a channel selected at the tuner in the base station apparatus 1 so that video signals of the selected channel can be obtained.

After the moving image signal selected by the moving image request command is obtained in this way, the processing in next step S304 is performed.

In step S304, it is determined whether a synthesized area as illustrated in FIG. 10C has any vacant area or not for assigning and synthesizing a moving image signal (the moving image signal to be obtained in step S303) to be newly added this time when the moving image signal output from the synthesizer 11 and input to the video encoder 12 currently has a currently defined resolution of a moving image to be synthesized. For the determination, the control portion 13 may monitor the state of an encoded moving image signal transferred from the video encoder 12 to the memory portion 14, for example. When the signal part corresponding to a vacant area into which moving image signals are not synthesized to a synthesized moving image signal is a black or white image, for example, the control portion 13 identifies how much the black or white image occupies the signal part as the state of the encoded moving image signal. The capacity of the vacant area can be recognized based on the identification result, and it can be determined whether the vacant area for the new moving image signal exists or not.

Then, if the positive determination result that a vacant area exists is obtained in step S304, the processing goes to step S309.

In step S309 and subsequent steps, the synthesizer 11 is controlled such that synthesizing processing can be performed after a moving image signal corresponding to the requested moving image (contents) this time is assigned to the vacant area in the synthesized area.

As a result of this processing, a synthesized moving image signal resulting from the additional synthesis of the moving image signal obtained in step S303 can be obtained.

In next step S310, processing is performed for transmitting extract command information from the communication portion 15 to the monitor apparatus 2 requesting the moving image in previous step S301.

Here, the extract command information includes information elements required for extracting a target moving image signal from the synthesized moving image signal.

For example, for a synthesized moving image signal as described with reference to FIG. 9A or 9B, information on a signal position, in the synthesized moving image signal, of a moving image signal to be extracted is stored. For a synthesized moving image signal as described with reference to FIG. 10C, information indicating a horizontal line position in the synthesized moving image signal including horizontal lines of moving image signals to be extracted, for example, is stored.

The moving image signal to be extracted by the extract command information created in step S310 is the same moving image signal as the one selected by the moving image request command received in response to step S301.

In step S310 subsequent to step S309, extract command information for extracting a moving image signal obtained in previous step S303 and newly added in step S309 is newly created, and, then, the extract command information is transmitted.

On the other hand, in step S310 as a result of the positive determination result obtained in step S302, extract command information does not have to be newly created. In other words, in this case, the selected moving image signal is being transmitted to a monitor apparatus, which means that the monitor apparatus 2 extracting and displaying the same moving image signal as the one selected this time already exists. This further means that the base station apparatus 1 has already created and transmitted extract command signal for extracting the same moving image signal as the one selected this time. Accordingly, extract command information for a moving image signal currently being transmitted is held so that the held extract information can be reused in step S310 in this case.

The transmission of extract command information from the base station apparatus 1 to the monitor apparatus 2 in step S310 is implemented by communication through unicasting only to the monitor apparatus specified as a destination and having transmitted the request for the moving image signal in response to S301. The transmission of extract command information may be defined as a response to a request for a moving image signal received in response to step S301.

After the processing in step S310 is performed, the processing moves to step S311, which will be described later.

If a negative result is obtained in step S304 indicating that an empty area for a moving image signal to be additionally synthesized this time is not available or is shorted, the processing moves to step S305.

In step S305, the resolution to be defined for present moving image signals to be synthesized is changed to a predetermined value one level lower than the predefined value. Thus, the resolution of each moving image signal to be synthesized in the synthesizer 11 is converted to the form as the moving image signal having the changed and defined resolution. According to this embodiment, the signal processing for a resolution change may be performed before synthesizing processing within the synthesizer 11.

In next step S306, the synthesizer 11 is controlled such that the present moving image signals to be synthesized can be re-synthesized in accordance with the synthesis pattern corresponding to the resolution changed in step S305.

In next step S307, the video encoder 12 is controlled such that the defined encoding rate for encoding can be changed in accordance with the resolution changed in previous step S305. Since the change in step S305 is performed for a smaller resolution, the encoding rate is changed to a smaller value also in step S307 therefor.

In next step S308, control processing is performed for transmitting extract command information to all monitor apparatus, which are the destination of a synthesized moving image signal created by the re-synthesis processing in step S306 as transmit moving image data.

In this case, since the re-synthesis processing is performed in previous step S306, the pattern of the moving image signal synthesized layout within the synthesized moving image signal is different from the one before the re-synthesis.

Accordingly, in step S308, extract command information is created first for commanding a method of extracting moving image signals to be synthesized to a synthesized moving image signal. In other words, extract command information is created for each moving image signal to be synthesized to a synthesized moving image signal. Then, the extract command information corresponding to a moving image signal requested by the monitor apparatus 2 to which the re-synthesized synthesized moving image signal is to be transmitted is transmitted to all of the monitor apparatus 2. Here, the extract command information is also transmitted to the monitor apparatus by communication through unicasting. After the processing in step S308 ends, the processing moves to step S311.

In step S311, control processing is performed for transmitting the present synthesized moving image signal resulting from the synthesizing processing by the synthesizer 11 from the communication portion 15 as transmit moving image data. Notably, the synthesized signal resulting from the synthesis in the synthesizer 11 is encoded and transferred to the communication portion 15 so that the synthesized signal can be transmitted from the communication portion 15 as transmit moving image data.

FIG. 13 shows a control processing operation corresponding to a signal processing operation for a case that transmit moving image data as a synthesized moving image signal is received by the monitor apparatus 2. The processing shown in FIG. 13 is implemented by the control portion 22, for example.

In step S201, the processing shown in FIG. 12 waits for a receipt of extract command information transmitted by the base station apparatus 1. When the receipt of extract command information is identified, the received extract command information is held in a predetermined storage area such as the memory 14 in next step S202. In next step S203, the processing waits for a start of the receipt of the trasnmit moving image data as a synthesized moving image signal transmitted by the base station apparatus 1. Then, when the start of the receipt of the data is identified, the processing moves to step S204.

In response to the start of the receipt of the transmit moving image data as a synthesized moving image signal in step S203, the monitor apparatus 2 starts signal processing and display control for decoding by the video decoder 24, transferring to the graphic controller 25 and displaying on the display portion 26 the received synthesized moving image signal.

Then, in step S204, the graphic controller 25 is controlled in accordance with details indicated by the extract command information held in step S202 so that, for example, one moving image signal can be extracted from the decoded synthesized moving image signal input to the graphic controller 25. Then, in next step S205, control processing is performed on the graphic controller 25 for displaying the extracted moving image signal on the display portion 26.

Thus, in the AV system of this embodiment, the base station apparatus 1 can properly obtain and synthesize a moving image signal required by the monitor apparatus 2 to a synthesized moving image signal and transmit the synthesized moving image signal. The monitor apparatus can properly extract and display a target moving image signal from the received synthesized moving image signal.

Having described the processing only relating to a moving image signal, contents information such as a television signal for an actual television broadcast and contents information output from an AV apparatus is not limited to a moving image signal but may have a form compliant with an audio signal to be reconstructed in synchronization with the moving image signal. For such a case, an audio signal corresponding to each moving image signal included in a synthesized moving image signal is preferably transmitted to the monitor apparatus 2 simultaneously so that the monitor apparatus can play the sound together with the display of the moving image signal.

In order to do so, a standard such as multi-channel and multi-lingual may be applied which is supported by an encoding technique such as MPEG-2, for example.

While, in this embodiment, one moving image signal is only extracted from a synthesized moving image signal in the monitor apparatus 2, required multiple moving image signals may be extracted from a synthesized moving image signal according to the concept of the invention. That is, the number of moving image signals to be extracted from a synthesized moving image signal is not limited in particular.

While an AV system including a base station apparatus and a monitor apparatus is provided, for example, in this embodiment, the invention is applicable to control systems having other forms. For example, instead of the base station apparatus and the monitor apparatus, a personal computer including an AV function as in this embodiment or a small terminal apparatus such as highly mobile and portable Personal Digital Assistants (PDA) may be adopted.

1. A transceiver system comprising:
a transmitter and a receiver,
the transmitter including:
synthesizing means synthesizing multiple moving image signals and creating a synthesized moving image signal thereby;
encoding means encoding a moving image signal to be input and outputting the encoded moving image signal and allowing the synthesized moving image signal to input as a moving image signal to be input; and
image signal transmitting means transmitting an encoded moving image signal output from the encoding means to multiple receivers, and
the receiver including:
image signal receiving means receiving an encoded moving image signal transmitted by the image signal transmitting means;
decoding means decoding an encoded moving image signal received by the image signal receiving means and outputting a moving image signal thereof; and
moving image signal extracting means, when a moving image signal output from the decoding means is the synthesized moving image signal, extracting a required moving image signal from multiple moving image signals synthesized to the moving image signal.

2. A transceiver system according to claim 1, comprising:
the transmitter further including extract command information transmitting means creating and transmitting extract command information for commanding a method of extracting a moving image signal from a synthesized moving image signal to each of multiple receivers, which are destinations that an encoded moving image signal resulting from encoding of the synthesized moving image signal by the encoding means is transmitted to by the image signal transmitting means; and
the receiver further including extract command information receiving means receiving the extract command information,
wherein the moving image signal extracting means extracts the required moving image signal from multiple moving image signals synthesized to a synthesized moving image signal decoded and output by the decoding means based on the extract command information received by the extract command information receiving means.

3. A transceiver system according to claim 1, comprising:
the receiver further including request information transmitting means transmitting request information for selecting and requesting a moving image signal to the transmitter; and
the transmitter further including request information receiving means receiving the request information,
wherein, when a new moving image signal is selected by the request information received by the request information receiving means, the synthesizing means adds and synthesizing the new moving image signal to a present synthesized moving image signal and creates a synthesized moving image signal thereby.

4. A transceiver system according to claim 1,
wherein the encoding means changes and defines an encoding rate for encoding in accordance with the number of moving image signal included in a synthesized moving image signal created by the synthesizing means.

5. A transceiver system according to claim 1, comprising:
the receiver further including request information transmitting means transmitting request information for selecting and requesting a moving image signal to the transmitter; and
the transmitter further including request information receiving means receiving the request information,
wherein, when a moving image signal selected by the request information received by the request information receiving means is already included in the synthesized moving image signal, the synthesizing means creates the same synthesized moving image signal as before.

6. A transceiver system according to claim 1,
wherein the synthesizing means creates the synthesized moving image signal such that images serving as multiple moving image signals to be synthesized are arranged under a predetermined arrangement rule.

7. A transceiver system according to claim 1,
wherein the synthesizing means creates the synthesized moving image signal such that horizontal lines each of multiple moving image signals to be synthesized are arranged under a predetermined arrangement rule.

8. A transceiver system according to claim 1,
wherein the image signal transmitting means transmits the encoded moving image signal to multiple receivers by broadcasting or multicasting.

9. A transmitter comprising:
synthesizing means synthesizing multiple moving image signals and creating a synthesized moving image signal thereby;
encoding means encoding a moving image signal to be input and outputting the encoded moving image signal and allowing the synthesized moving image signal to input as a moving image signal to be input;
image signal transmitting means transmitting an encoded moving image signal output from the encoding means to multiple receivers; and
extract command information transmitting means creating and transmitting extract command information for commanding a method of extracting a moving image signal from a synthesized moving image signal to each of multiple receivers, which are destinations that an encoded moving image signal resulting from encoding of the synthesized moving image signal by the encoding means is transmitted to by the image signal transmitting means.

10. A receiver comprising:
image signal receiving means receiving an encoded moving image signal transmitted from a transmitter;
decoding means decoding an encoded moving image signal received by the image signal receiving means and outputting a moving image signal thereof;
extract command information receiving means receiving extract command information transmitted from a transmitter for commanding a method of extracting a moving image signal from a synthesized moving image signal; and
moving image signal extracting means, when a moving image signal output from the decoding means is the synthesized moving image signal, extracting a required moving image signal from multiple moving image signals synthesized to the synthesized moving image signal based on extract command information received by the extract command information receiving means.

11. An information processing method for a transceiver system including a transmitter and a receiver,
the method comprising:
by means of the transmitter,
a synthesizing step of synthesizing multiple moving image signals and creating a synthesized moving image signal thereby;
an encoding step of encoding a moving image signal to be input and outputting the encoded moving image signal and also encoding the synthesized moving image signal as the moving image signal to be input; and
an image signal transmitting step of transmitting an encoded moving image signal output from the encoding step to multiple receivers, and
by means of the receiver,
an image signal receiving step of receiving an encoded moving image signal transmitted by the image signal transmitting step;
a decoding step of decoding an encoded moving image signal received by the image signal receiving step and outputting a moving image signal thereof; and
a moving image signal extracting step of, when a moving image signal output from the decoding step is the synthesized moving image signal, extracting a required moving image signal from multiple moving image signals synthesized to the moving image signal.

12. An information processing method for a transmitter, comprising:
a synthesizing step of synthesizing multiple moving image signals and creating a synthesized moving image signal thereby;
an encoding step of encoding a moving image signal to be input and outputting the encoded moving image signal and also encoding the synthesized moving image signal as the moving image signal to be input;
an image signal transmitting step of transmitting an encoded moving image signal output from the encoding step to multiple receivers; and
an extract command information transmitting step of creating and transmitting extract command information for commanding a method of extracting a moving image signal from a synthesized moving image signal to each of multiple receivers, which are destinations that an encoded moving image signal resulting from encoding of the synthesized moving image signal by the encoding step is transmitted to by the image signal transmitting step.

13. An information processing method for a receiver, comprising:
an image signal receiving step of receiving an encoded moving image signal transmitted from a transmitter;
a decoding step of decoding an encoded moving image signal received by the image signal receiving step and outputting a moving image signal thereof;
an extract command information receiving step of receiving extract command information transmitted from a transmitter for commanding a method of extracting a moving image signal from a synthesized moving image signal; and
a moving image signal extracting step of, when a moving image signal output from the decoding step is the synthesized moving image signal, extracting a required moving image signal from multiple moving image signals synthesized to the moving image signal based on extract command information received by the extract command information receiving step.
